(19) United States
(12) Patent Application Publication
(10) Pub. No.: US 2004/0024764 A1
(43) Pub. Date: Feb. 5, 2004

(54) Assignment and management of authentication & authorization

(76) Inventors: Jack Hsu, Tempe, AZ (US); Derwin Skipp, Tempe, AZ (US)

Correspondence Address: CHRISTIE, PARKER & HALE, LLP, 350 WEST COLORADO BOULEVARD, SUITE 500, PASADENA, CA, 91105, US

(21) Appl. No.: 10/465,717

(22) Filed: Jun. 18, 2003

Related U.S. Application Data
(60) Provisional application No. 60/389,864, filed on Jun. 18, 2002.

(51) Int. Cl. G06F 17/30

(52) U.S. Cl. 707/9

(57) ABSTRACT

A system and method for providing user authentication and authorizations for an enterprise. An enterprise dynamic network authorization system includes an authorization server that receives requests from users for access to services. The authorization server uses user service subscriptions and access rules associated with the services to determine if the user should be authorized to access a service. The system may provide authentication for provisioned services having their own authentication databases through the use of an authorization remote management interface. The system may further include an administration server coupled to the authorization server. The administration server may be used by an administrator to add, modify, and delete user authorizations within the enterprise dynamic network authorization system and remote systems using the authorization remote management interface.

### CROSS-REFERENCE TO RELATED APPLICATION

The present application claims priority to U.S. Provisional Patent Application No. 60/389,864, filed Jun. 18, 2002 which is hereby incorporated by reference as if set forth in full herein.

### BACKGROUND OF THE INVENTION

This invention pertains generally to providing authorization for software services and more specifically to providing authorizations within an enterprise computer system.

Computer systems used by organizations or institutions are termed enterprise systems because they service the needs of a large number of interrelated users. An enterprise system may include a number of individual computer systems linked together within a computer network. These computer systems may be of different types having different operating systems and data formats. Even when these computer systems share the same operating system and data formats, the computer systems themselves may be supplied by different vendors. In addition, the computer network linking these disparate computer systems may be heterogeneous as well. Because the computer systems and computer networks are so different, there is a tendency for administrators to manage each system or network on an ad hoc basis. This management style may result in management inefficiencies as administrators are constantly forced to adapt to the ever changing needs of the complex enterprise system.

The complexity and size of an enterprise system is reflected in the complexity and size of the enterprise system's user base. Enterprise systems exist to serve a large number of users who's needs and tastes may be quite different. In addition, the user base is dynamic. Each day new users are entering the system and current users change roles or leave.

The combination of a large number of computer systems, heterogeneous networks, and a dynamic user base makes maintenance of an enterprise system difficult. This is because, in part, the users and the administrators may have competing interests. Regardless of the large number of computer systems and heterogeneous networks within the enterprise, users of an enterprise system demand access to computing services in a timely fashion. Administrators, on the other hand, desire centralized maintenance tools that allow them to efficiently manage the enterprise system. The use of centralized tools may interfere with a user's expectations of timely access. For example, if a user is requesting access to a service, the user does not want to wait while a centralized database is consulted each and every time the user access the service.

Therefore, a need exists for an enterprise wide authentication and authorization system allowing administrators to maintain the authentication and authorization system while still meeting user's expectations of timely access to the enterprise system. Various aspects of the present invention meet such a need.

### SUMMARY OF THE INVENTION

In one aspect of the present invention, a system is provided for automated authorization and management of authentication and authorization. An administrator uses the system to manage access to resources and services based on dynamic rule based criteria using electronically identifiable user and service attributes or parameters.

In one aspect of the invention, automated management of authentication and authorization of user accounts is used to permit active, dynamic management of user access to Web based services and e-commerce applications across distributed databases and computers without regard to device type, operating system, or manufacturer. In another aspect, the invention accurately and securely identifies account users, automatically assigns and manages access to services based on hierarchical and dynamic rules and decision protocol in real-time and functions on both central and distributed computer networks.

In another aspect, the invention includes, but is not limited to, a process for real-time remote verification of authorization and account management using multiple servers in a distributed computing environment to improve security, and minimize the ability to circumvent a system to gain illicit access. In another aspect, the invention supports computer mediated authorization using any electronic code key or device to create an intelligent virtual or physical authorization portal. The invention also, in one aspect, tracks administrative access and transactions, such as by creating an audit trail for verification of changes to rules and decision protocol as well as any modification of account information or access capabilities by others. As such, accountability for system administrative activities is provided.

The invention differs from current static, batch processed techniques in that it incorporates scalable, extensible real-time management of authentication and authorization rules. The invention also includes, but is not limited to, a number of design capabilities. For example, the invention provides centralized access policies with distributed management, distributed management of authorization rules and permissions, automated addition, removal, and management of authorization elements and permissions. Further examples include, but are not limited to, secure self-subscription to services, synchronized double entry security, service scalability and extension, and central electronic identity management.

The ability to provide real-time management of authentication of users and authorization of services based on a decision protocol has commercial potential in numerous types of e-commerce and web service applications. For example, web portals may use the invention for the identification of users and dynamic, real-time management of security and access to services. Other examples include, but are not limited to, management of user access to services within e-commerce sites, management of internal access based on dynamic rule based criteria using identity, role, location, or other electronically identifiable attributes or parameters, internal accountability for system administration, and simplified but secure access across multiple services operated on multiple servers, and/or by distributed service units or business providers.

Accordingly, the invention provides systems and methods for automated assignment and management authentication and authorization to manage access to resources and services based on dynamic rule based criteria using electronically identifiable attributes or parameters.

In one aspect of the invention, a method of providing access to a service by a principal via a communications network is provided. A server receives a request for authorization via the communications network from a client coupled to the service. The request for authorization includes contextual data about the service and the principal. The server selects an access rule from a database using the contextual data. The server then determines an action using the access rule and the contextual data. The action indicates if the principal may access the service. The server transmits the action via the communications network to the client. In response, the client provides access to the service by the principal if the action indicates the principal is authorized to access the service.

In another aspect of the invention, the database further includes an association between the principal and the service. The server determines an action by generating a database query using the contextual data and a query template associated with the access rule. The server then uses the query to get a response from the database. The server then determines access rule evaluation results using the response which the server uses to determine the action.

In another aspect of the invention, the server stores the access rule evaluation results in a cache for further reference. When the server receives a subsequent authorization request via the communications network from the client, the server uses the cached evaluation results to determine an action for the subsequent authorization request.

### BRIEF DESCRIPTION OF THE DRAWINGS

These and other features, aspects, and advantages of the present invention will become better understood with regard to the following description, attached claims, and accompanying drawings where:

FIG. 1a is a deployment diagram of an enterprise dynamic network authorization system for a non-provisioned service from a principal's perspective in accordance with an exemplary embodiment of the present invention;

FIG. 1b is a deployment diagram of an enterprise dynamic network authorization system for a provisioned service in accordance with an exemplary embodiment of the present invention;

FIG. 1c is a deployment diagram of an enterprise dynamic network authorization system from an administrator's perspective in accordance with an exemplary embodiment of the present invention;

FIG. 2 is an entity relationship diagram for an enterprise dynamic network database in accordance with an exemplary embodiment of the present invention;

FIG. 3 is a process flow diagram of an authorization process used to authenticate a target principal and then provide authorization for the targeted principal's use of a targeted service in accordance with an exemplary embodiment of the present invention;

FIG. 4 is a process flow diagram of an access rule evaluation process used to determine a target principal's authorization in accordance with an exemplary embodiment of the present invention;

FIG. 5 is a sequence diagram of a dynamic access control entry generation process in accordance with an exemplary embodiment of the present invention;

FIG. 6 is a sequence diagram of an administration process for changing a principal's status with an external authorization system in accordance with an exemplary embodiment of the present invention; and

FIG. 7 is an architecture diagram for a data processing system suitable for use as a host for an enterprise dynamic network authorization server or administration server in accordance with an exemplary embodiment of the present invention.

### DETAILED DESCRIPTION

An enterprise dynamic network authorization system enables computer mediated access to a computing service. A service is an abstracted representation of any computer-based offering that uses access control. Services may occur as one of two types, provisioned services that use management of external authorization systems, and nonprovisioned services that rely upon the enterprise dynamic network authorization system's dynamic access control entry. A service can be a computer account, an entry in a password or other authorization file, a membership in a security group, access to an application, a software application function, etc.

Provisioned services are those that have their own authorization database, such as Unix password files, IBM RACF, Network Information Services (NIS), Lightweight Directory Access Protocol (LDAP) entries, etc. Non-provisioned services are those that rely entirely on service definitions stored in an enterprise dynamic network authorization system database and can be used to associate access rules for applications and functionality within applications.

Within the context of authentication and authorization, an entity other than a living person may access a service. For example, a software object running as an autonomous process may need to access services for system maintenance or monitoring purposes. As such, any entity attempting to access a service is herein termed a “principal”. A principal may have a network identification, a user identification such as a user id, or another kind of electronic identity.

Provisioned services typically include a further restriction placed on an authorization system. Provisioned services may use a command line interface or Application Programming Interface (API) to allow programmatic management. A simple example: to provide access to a Unix or Linux system an entry must exist in the /etc/passwd file which defines the userid, password, unique numeric user identification (UID), group identification (GID), descriptive information such as a user's name, the default directory within the Unix file system, and the default shell or initial program. The enterprise dynamic network authorization system has programs or scripts that can manipulate these entries via a Remote Management Interface (RMI).

The enterprise dynamic network authorization system defines an association between a principal and a service as a subscription to that service. As a result, every provisioned service has an associated subscription record. The enterprise dynamic network authorization system includes six actions that can be performed to define or determine the subscription status, a principal can: 1) be granted access; 2) have access suspended; 3) have access reactivated; 4) have access removed; 5) have attributes modified for a service subscription; and 6) query any or all of the attributes associated with a service subscription.

Mediation to services is provided by authentication and authorization processes. Authentication is the means to prove that individuals are who they present themselves to be. Once an individual has been authenticated, any computer mediated access can be authorized for specific identities. Authorization asks the simple question: “Can this principal access this service?”

The enterprise dynamic network authorization system creates a rules-based authorization mechanism to grant or deny access to services. Each service is related to one or more access rules which define the criteria that must be satisfied when requesting subscription to a service. The enterprise dynamic network authorization system administrators and service coordinators are granted special permission to override access rules and establish exception subscriptions.

An access rule can be viewed as a schema for a dynamic access control entry. An access rule dynamically controls membership in an identifiable group based upon the satisfaction of one or more propositions executed in the context of a given principal, a specific service, and program contextual variables.

Furthermore, since an enterprise view of the enterprise dynamic network authorization system services may become obfuscated by sheer volume, the enterprise dynamic network authorization system organizes services into a hierarchical namespace to provide easier management.

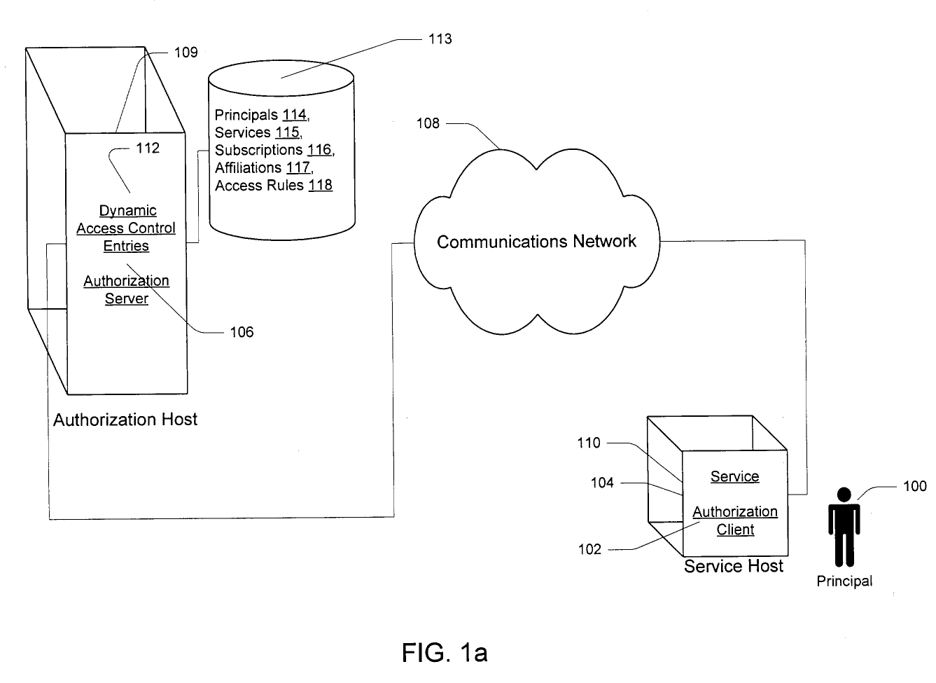

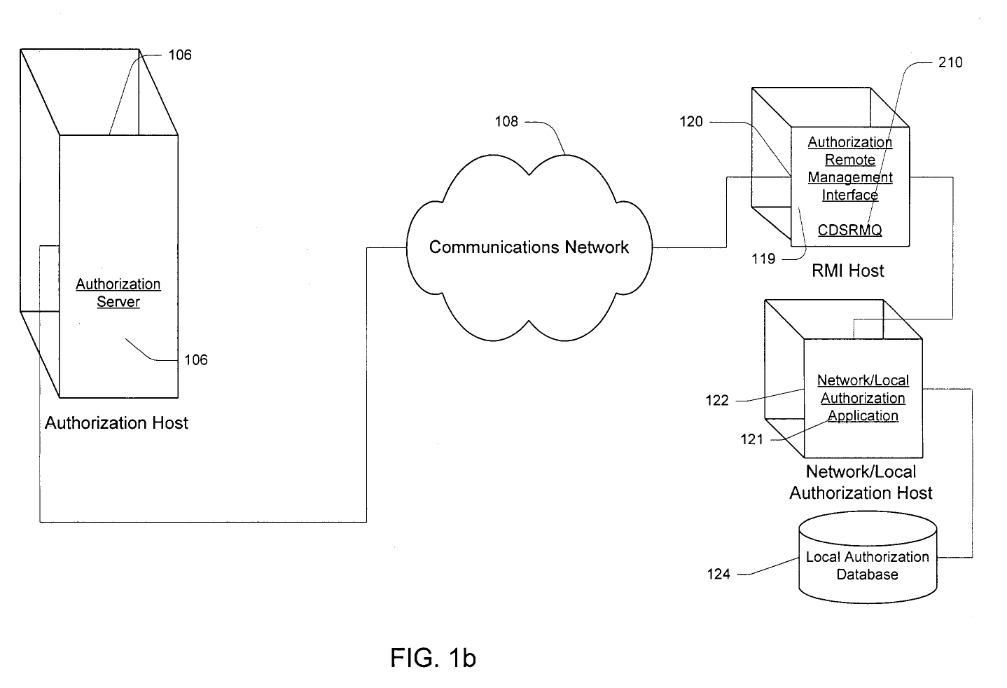

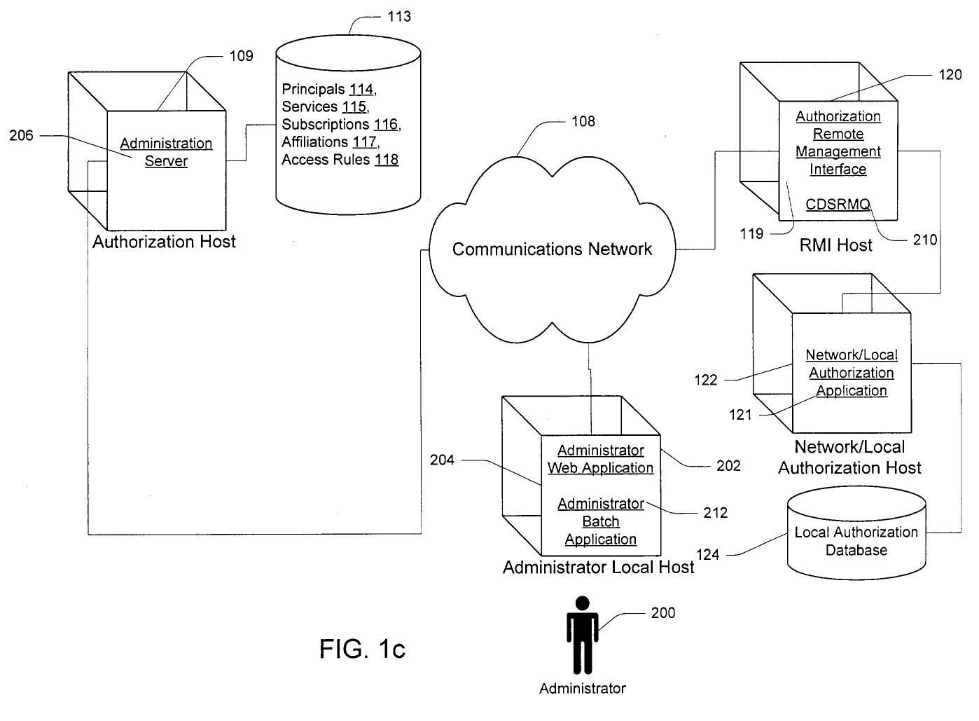

FIG. 1a is a deployment diagram of an enterprise dynamic network authorization system from a principal's perspective in accordance with an exemplary embodiment of the present invention. A principal 100 accesses a service 110 hosted by a service host 104. The service uses an authorization client 102 coupled to the service to access an authorization server 106 via a communications network 108. The authorization server is hosted by an authorization host 109. The authorization client requests authorization from the authorization server for the principal to access the service. If the response from the authorization server indicates that the principal may access the service, the service allows the principal access.

The authorization server provides dynamic evaluations of access rules 111 as well as management for access rule evaluation results cached in dynamic access control entries 112. The authorization request may include contextual data such as principal attributes and service identifiers that are used with access rules by the authorization server to query a database 113. The database includes information about principals 114, services 115, subscriptions 116, affiliations 117, and access rules 118.

Principals are associated through affiliations. For example, in an educational institution, a principal may have at least one, but may have two or more relationships to the institution. Examples would be a student affiliation, a faculty affiliation, or staff affiliation. Faculty and staff may have one affiliation per department that they may be in. Students may have one affiliation per major. Someone may even be a student, a faculty member, and a staff member at one time. There can also be many institutionally defined courtesy affiliations for those individuals that are neither students, faculty, nor staff.

Whether or not a principal may access the service is determined by evaluation of the access rules associated with a service. The access rules may include database query templates that are used to query the database about the principal's affiliations. These relationships are used by the authorization server to determine if the principal as affiliated with one or more user groups authorized to access the service. If the principal is determined to be affiliated with a user group authorized to use the identified service, the authorization grants an authorization to the authorization client for the principal to use the service.

A principal may also gain access to service through the use of exceptions. For example, some subscriptions define some form of permission to access a service regardless of the principals fulfillment of access rules. There are constraints on these exceptions such as an expiration date, or association to an affiliation that would not otherwise allow the principal access.

Groups may also be used to define the relationship between principals and services. Implied group membership is what is determined by evaluating an access rule in the context of a principal. However, explicit groups may be defined through relationships in the database as well. When a service is associated to a group within the database, there is an implied access rule. Therefore, implied groups occur because of evaluation of access rules, and implied access rules occur because of explicit group membership and services associated to the explicit group.

Rather than relying upon static access control lists made up of one or more static access control entries, the authorization server establishes the temporary dynamic access control entries created when the authorization server evaluates an access rule. A dynamic access control entry exists from the time of evaluation of the access rule in the context of the current principal until the expiration of a predetermined timeout period. Whereas static access control entries only capture the fact that an access has been granted for unknown reasons, the dynamic access control entry represents truth values associated with access criteria being met, and thus a determinate in making authorization decisions.

Authorization requests are mediated by the dynamic access control entries as the dynamic access control entry serves as a cache for access rule evaluation results. By caching the evaluation rule results, the authorization server may avoid the necessity of evaluating a set of access rules each time the principal accesses a service. For example, if the principal needs to repeatedly access a specific service during a single session, the authorization server can simply consult the dynamic access control entries to determine that the principal should be authorized. This may avoid repeatedly querying the database to simply get the same response each time.

In one authorization server in accordance with an exemplary embodiment of the present invention, the authorization server processes extensible Markup Language (XML) authorization requests from authorization clients located on the local service host. The authorization server evaluates access rules for each principal and returns an XML message reflecting a decision to permit or deny authorization.

FIG. 1b is a deployment diagram of an enterprise dynamic network authorization system for a provisioned service in accordance with an exemplary embodiment of the present invention. An authorization server 106 may use an authorization remote management interface 119 to obtain authorizations and effect changes to service authorizations for provisioned services. The authorization remote management interface is a client/server application that runs on a service authorization host, such as remote management interface host 120. There are several protocols supported with the protocols based on the remote procedure call mechanism used for communication between the administration server and the authorization remote management interface.

The remote management interface is a server application that processes XML management requests from the authorization server. The remote management interface executes local executables in order to enact changes in external authorization systems. The remote management interface protocol provides local executables responsible for Creating, Deleting, Suspending, Reactivating, Modifying, or Querying external authorizations (CDSRMQ) 210.

The remote management interface accesses one or more network or local authorization applications 121 hosted by a network local authorization host 122 to generate authentication credentials for use by the authorization server 106 (FIG. 1a). The network or local authorization applications may access a local authorization database 124 to determine if a principal is authorized to have an authentication credential for a specific service. The network or local authorization applications may include a variety of systems and authentication credential sources of varying scale and complexity. For example, standalone workstations maintaining a local password file, clusters utilizing NIS or NetInfo, or servers providing enterprise wide authentication or authorizations may all be used to provide authentication credentials.

In one remote management interface in accordance with an exemplary embodiment of the present invention, a trusted third party shared symmetric key based authentication system known as “Kerberos” is used. Kerberos includes a mechanism that does not expose a password on a network.

In one authorization server in accordance with an exemplary embodiment of the present invention, the administration server communicates using authenticated XML messages.

FIG. 1c is a deployment diagram of an enterprise dynamic network authorization system from an administrator's perspective in accordance with an exemplary embodiment of the present invention. The enterprise dynamic network authorization system includes facilities for use by an administrator in setting rights for a principal's access to various services. An administrator 200 uses an administrator Web application 202 hosted by an administrator local host 204 to access an administration server 206 via a communications network 108. The administration server may be hosted by the authorization host 109.

An administrator may also use an automated batch system 212 to maintain the integrity of computer access rights. Though it is relatively simple to add principals to computer access systems, it is an ongoing challenge to remove the principals, particularly in a distributed computing environments. The automated batch system allows an enterprise dynamic network authorization system to maintain information about system principals, and to react when new principals are added, when others leave, and when a principal's job, class, or department information changes. The automated batch system also maintains synchronization between the enterprise dynamic network authorization database 113 and the state of access information on remote service hosts and in external authorization databases.

The administrator may also use the administration server to reference or update the enterprise dynamic network authorization database having information about principals 114, services 115, subscriptions 116, affiliations 117, and access rules 118. In addition, the administrator may use the administration server to send transactions requests to an authorization remote management interface 119 to create, modify, or remove a principal's access to a service.

The remote management interface is a server application that processes XML management requests from the administration server. The remote management interface executes local executables in order to enact changes in external authorization systems. The remote management interface protocol provides local executables responsible for creating, deleting, suspending, reactivating, modifying, or querying external authorizations 210.

The remote management interface accesses one or more network or local authorization applications 121 hosted by a network local authorization host 122 to generate authentication credentials for use by the authorization server 109 (FIG. 1a). The network or local authorization applications may access a local authorization database 124 to determine if a principal is authorized to have an authentication credential for a specific service as previously described.

In one administration server, the administration server also acts as a forwarding agent for other enterprise dynamic network authorization system administration processes in order to efficiently deploy an enterprise dynamic network authorization system service namespace to enhance performance and availability. In the enterprise dynamic network authorization system service namespace, each service is provided with a unique identifier or name in a hierarchal system. An example of such a system is Distributed File System (DFS) standard. The DFS standard includes: a universal name space wherein files are identified in a consistent location regardless of which networked computer makes a file request; all files are rooted at /dfs; client caches to minimize network traffic; strong network authentication utilizing Kerberos; user files aggregated into a volume construct makes migrating volumes to different servers or partitions easier; and location independence, wherein user volumes may migrate to different servers or partitions without user awareness.

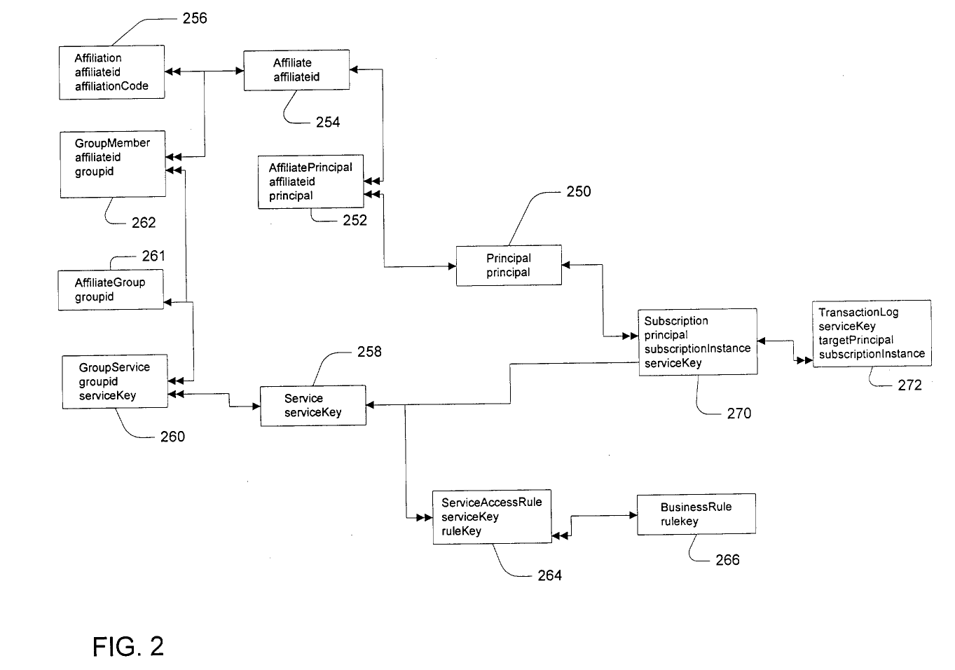

FIG. 2 is an entity relationship diagram for an enterprise dynamic network authorization system database in accordance with an exemplary embodiment of the present invention. In the authorization table, a principal is associated to service authorizations by the principal's affiliations. The associations are maintained using a set of database tables. A principal table 250 has a one to many relationship to an affiliate principal table 252. The affiliate principal table in turn has a many to one relationship with an affiliate table 254. The affiliate table has a one to many relationship with an affiliation table 256. By associating a principal through the affiliation tables, a principal may have one or more affiliations.

Services are also associated with the affiliate table through a set of group tables. A service table 258 includes information about a service that a principal may want to use. The service table includes a service key field for an identifier of a service. The service table has a one to many relationship to a group service table 260. The group service table in turn has a one to many relationship to a affiliate group table 261. The affiliate group table in turn has a one to many relationship to a group member table 262. Finally, the group member table has a many to one relationship to the affiliate table.

A subscription table 270 has a one to one relationship to the service table, and the service table has a one to many relationship with the subscription table. The principal table has a one to many relationship to the subscription table. Therefore, principals may be associated with services through the subscription table.

In operation, an administrator may use an administration server to add, modify, and delete a principal's authorizations to services either as a group or individually. To do so, the administrator need only to adjust the principal's affiliations and subscriptions by modifying the affiliated principal and subscription tables linked to the principal table.

Each service is also associated with a set of access rules within the databases. The service table has a one to many relationship to a service access rule table 264. The service access rule table is further related in a many to one relationship to an access or business rule database 266. Therefore, through the data tables, a service may be associated with one or more access rules.

In operation, an authorization server uses the service table's related service access rule table to select a set of access rules to evaluate. For a given service, the authorization server follows the associations to the one or more service access rules and evaluates the selected access rules. If an access rule is successfully evaluated, the authorization server allows a principal to access the requested service.

Access rules can also take into consideration an affiliates membership in an group, or attributes associated with the principal, or attributes from external databases that can be referenced through the principal's owning an affiliate identity.

A database may further include data tables used to maintain a transaction log. The principal table 250 has a one to many relationship to the subscription table 270. The subscription table has a one to many relationship to a transaction log table 272. In operation, changes to a principal's subscription status to provisioned services are logged in the subscription and transaction log.

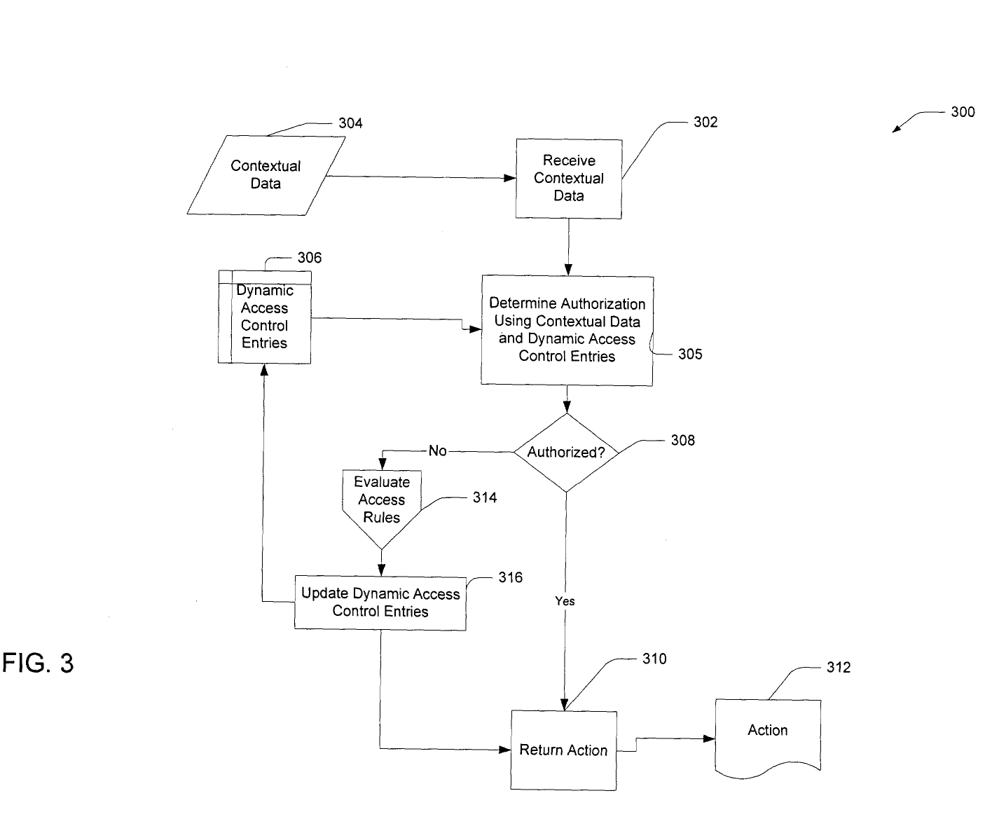

FIG. 3 is a process flow diagram of an authorization process used to provide authorization for the targeted principal's use of a targeted service in accordance with an exemplary embodiment of the present invention. During an authorization process 300, an authorization server receives (302) contextual data 304 from an authorization client requesting authorization to a service on behalf of a principal. The contextual data may include principal identity information, target service identification, and attribute values. The contextual data is used along with cached access rule evaluation results in the form of dynamic access control entries 306 to determine (305) if the principal should receive an authorization for the target service. If the cached access rule evaluations in the dynamic access control entries indicate (308) that there is a successful hit, then an action 312 associated with the access rule being evaluated is returned (310) to the authorization client requesting authorization. The action can be either to deny access, permit access, or for provisioned services, report that the access request has been forwarded for consideration by a service coordinator.

If the dynamic access control entries do not contain enough information in order to authorize the principal to use the service, the authorization process evaluates (314) a set of evaluation rules associated with the service to determine if the principal should be authorized. The access rule evaluation results are then stored (316) in the dynamic access rule entries by the authorization server. This may enhance performance and minimize the number of round trips to targeted data stores. The dynamic access control entries capture the reasons for granting or denying access as opposed to just the fact that an access has been granted or denied. Once the rule is evaluated and the evaluation results cached, then an action is returned to the authorization client.

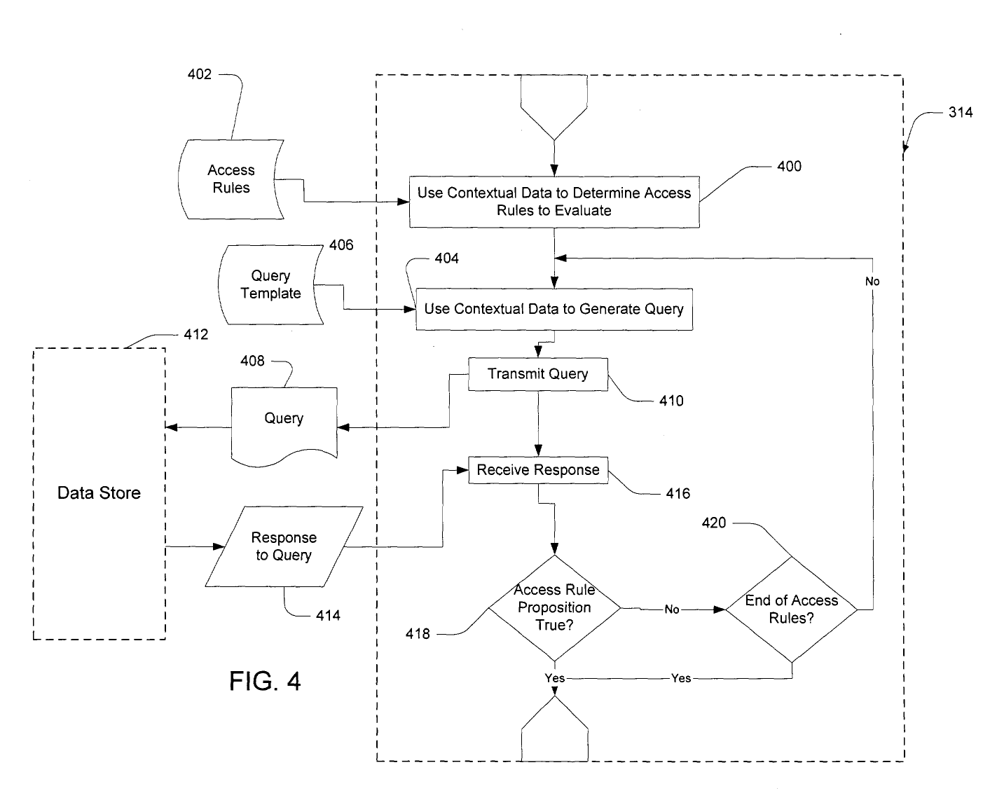

FIG. 4 is a process flow diagram of an access rule evaluation process used to determine a target principal's authorization in accordance with an exemplary embodiment of the present invention. An access rule provides systems and methods for self subscription to managed services. In addition, access rules provide dynamic evaluation of authorization requests for non-provisioned services. Access rules associated with the target service are evaluated by an authorization server using contextual data about the target principal and service. Access rules dynamically determine the group membership of principals based on the satisfaction of propositions. Access rule propositions may be dynamically constructed from client application information, system variables, and database Structured Query Language (SQL) queries.

Database access rules are a collection of template SQL statements which are run using contextual data about the target principal. The database access rules also allow SQL searches through any database accessible through the implementation of an object persistence framework. During an access rule evaluation process 314, an authorization server uses contextual data to select (400) a set of access rules to evaluate from a plurality of stored access rules 402. If no access rules are found for a service, then the default authorization result or action is no access granted. Each access rule proposition in the selected set of access rules is evaluated to determine if an access rule proposition is true. The access rules include query templates 406 used along with the contextual data to generate (404) a query 408. The query is used to query a data store 412 such as a database. The data store may be local or remote with regard to the authorization server evaluating the access rule. The query is processed and a response 414 is generated. The access rule evaluation process receives (416) the response. When processing access rules, rule scanning stops (418) after the first occurrence of a successful hit. That is, the access rule either includes a proposition returning a TRUE value or a query that returns one or more rows from a queried database. Otherwise, if the first access rule is found not to apply for the current target principal, the next access rule is processed until a hit is found, or the end of the access rules (420) for the target service is reached.

Access rules may include processes for evaluation of simple propositions such as testing if a system variable is true, or may include complex retrieval processes from remote databases or data stores. Access rules in accordance with an exemplary embodiment of the present invention have the following syntactical features. In the access rules, a “#” symbol prefixes token place holders for identity attributes in the context of a current authenticated principal. A “@” symbol prefixes token place holders for current client contextual data. A “$” symbol prefixes token place holders for system variables. Service contextual data is used to identify the required access rules. Query template rules have two parts, the first identifies the target database, and the second is the query template. Access rules are not limited to query templates and may be based on other types of contextual data such as the current time or an client IP address, etc.

The following access rule is for authorizing access to a service based on the day of the week:

% currentDay in (“Monday”, “Tuesday”, “Wednesday”, “Thursday”, “Friday”) and % currentHour between (8,17)

The following access rule is for accessing a service based on an IP address:

@clientIP like 129.219.*.*

The following access rule is an SQL template for accessing a service by a faculty member:

EDNA:select * from Affiliation where affiliateId=#‘AFFILIATEID and affiliationCode=‘F’ and inactiveCode=‘A’

The following access rule is (SQL) template for accessing a service for a instructor of record at a University:

SISREP:select * from db2inst1.id_rec ir, db2inst1.class_rec cr, db2inst1.instr_class_rec icr where (cr.year=@‘year and cr.term=@‘term and cr.sln=@sln and ir.asu_id=#‘SCHOOLID and cr.p_k=icr.f_k_class_inst_set and ir.p_k=icr.f_k_instr_set)

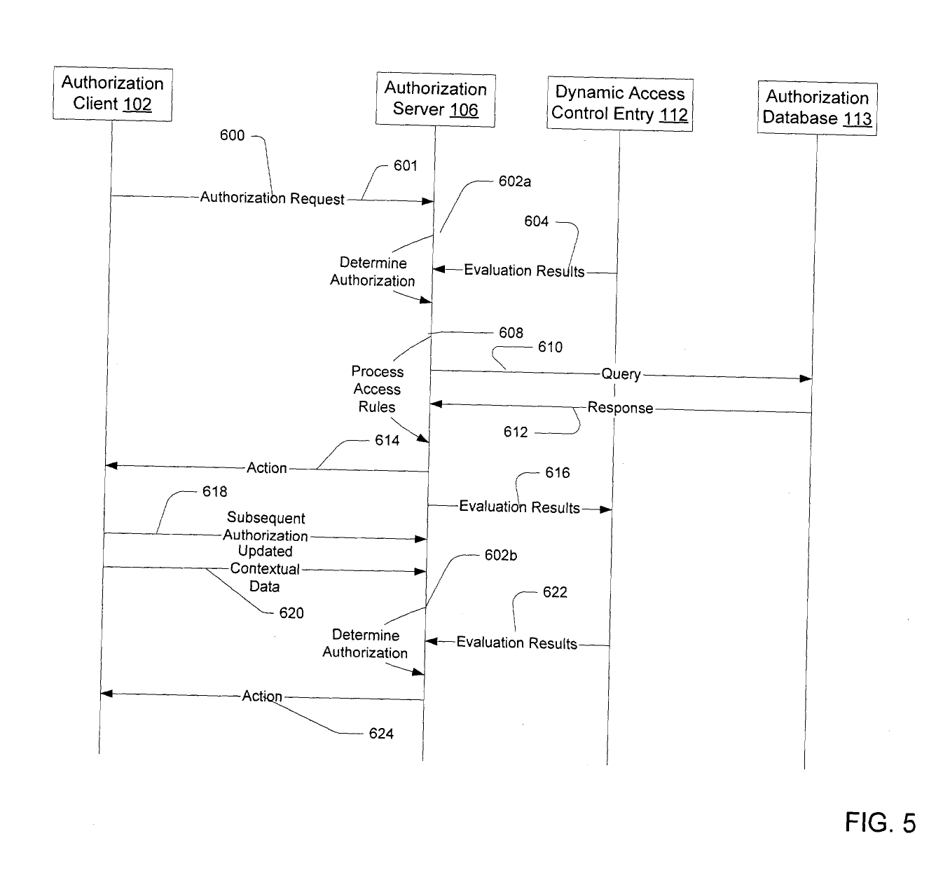

FIG. 5 is a sequence diagram of a dynamic access control entry generation and use process in accordance with an exemplary embodiment of the present invention. As previously noted, an authorization server may use a dynamic access control entry to cache access rule evaluation results for further reference. An authorization client 102 collects contextual data about a target principal and a service. The contextual data may include principal identity information, target service identification, and attribute values. The contextual data is included in a authorization request 600 and transmits the contextual data to an authorization server 106. The authorization server uses access rule evaluation results 604 stored in the dynamic access control entry 112 to determine (602a) if the principal is authorized to access the targeted service. If the stored evaluation results do not include useful evaluation results, the authorization server evaluates (608) a set of access rules. During the evaluation process, one or more queries 610 are generated and used to query a database 113. The authorization server uses the responses 612 to the queries to determine which action 614 should be transmitted back to the administration server 106 for forwarding to the authorization client. The evaluation results 616 from the access rule evaluation are then stored in the dynamic access control entry.

Upon receiving a subsequent authorization request 618 having updated contextual data 620, the authorization server uses the previously stored evaluation results 622 stored in the dynamic access control entry to determine (602b) the appropriate action 624 to transmit to the authorization client. As the evaluation results were cached in the dynamic access control entry, the authorization server did not need to access the database again.

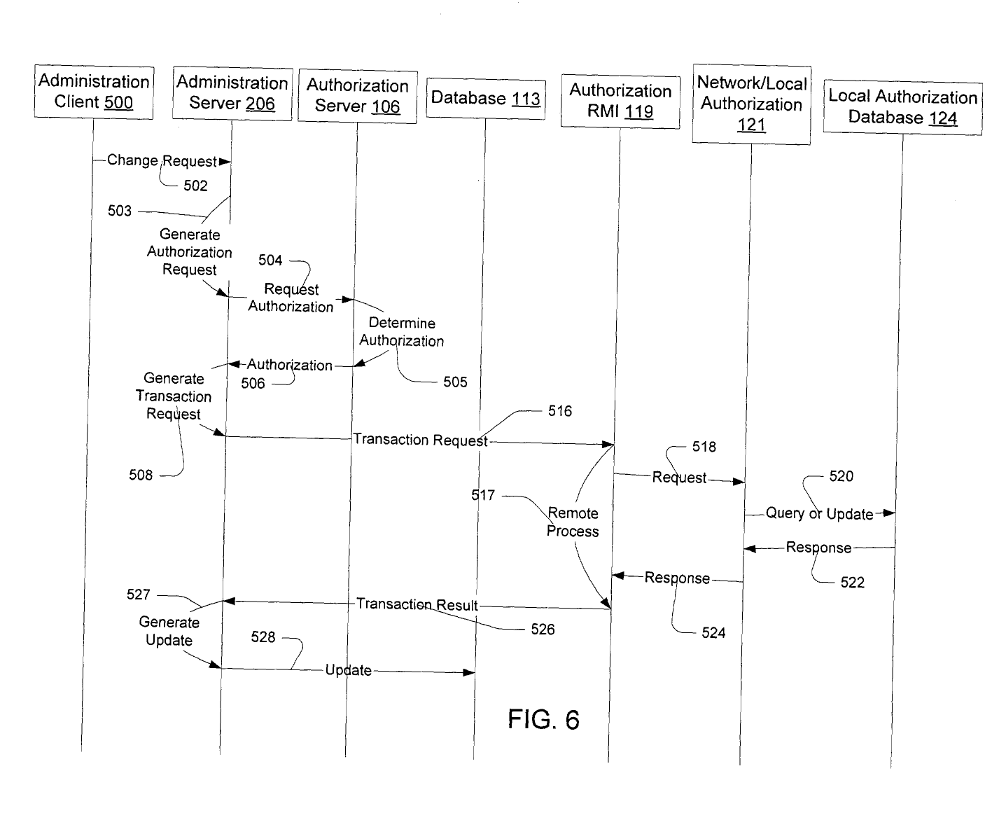

FIG. 6 is a sequence diagram of an administration process for changing a principal's status with an external authorization system in accordance with an exemplary embodiment of the present invention. An enterprise dynamic network authorization system may affect changes in external authorization systems for use by provisioned services. Once a service is provisioned, all authorization requests go through the external authorization system. However, the enterprise dynamic network authorization system may query, modify, suspend, reactivate, or remove a principal's authorizations on the external authorization system.

An administrator 200 (FIG. 1c) may use an administration client 500, such as an administrator web application 202 or administrator batch application 212 (FIG. 2) to access an administration server 206 and transmit a change request 502. The change request may be to modify, suspend, reactivate, remove, or simply query a principal's authorizations on an external authorization system. The change request includes contextual data such as attributes associated with a service subscription for a principal. The administration server uses the change request to generate (503) a request for authorization 504 that is transmitted to an authorization server 106. The authorization server uses contextual data included in the request for authorization to determine (505) if a principal may be authorized for the target service as previously described. The authorization server then transmits an appropriate authorization 506 to the administration server.

If the authorization indicates that the principal is allowed access to the target service, the administration server generates (508) and transmits a transaction request 516 to a remote management interface 119. The transaction request includes portions of the contextual data that the remote management interface may use to update the principal's status in an external authorization or authentication system. In response to the transaction request, the remote management interface invokes a process or executes a script (517) that generates a request 518 for transmission to a network/local authorization application 121. The network/local authorization application receives the request and uses the request to generate and transmit a query or update 520 to a local authorization database 124. The network/local authorization application uses the response to generate a response 524 which is received by the remote management interface. The remote management interface uses the response to generate a transaction result 526 that is transmitted back to the administration server. The administration server then generates (527) an update for an enterprise dynamic network authorization database 113 reflecting the change in status of the principal, such as a modification, suspension, reactivation, or removal of a principal's authorizations for a service.

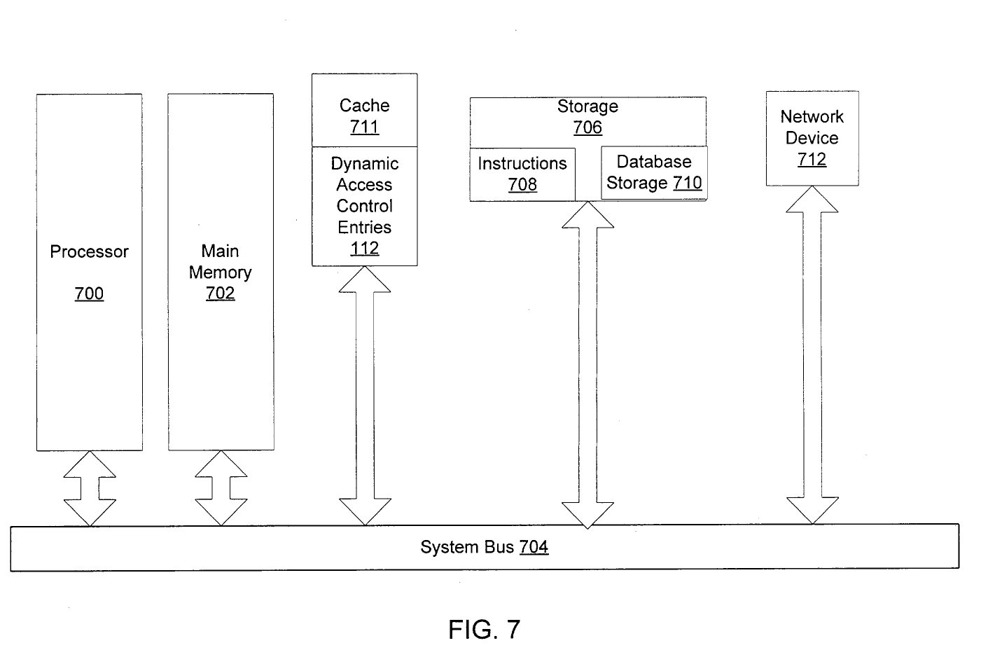

FIG. 7 is an architecture diagram for a data processing system suitable for use as a host for an enterprise dynamic network authorization server or administration server in accordance with an exemplary embodiment of the present invention. A data processing system includes a processor 700 coupled to a main memory 702 via a system bus 704. The processor is also coupled to a data storage device 706 via the system bus. The storage device includes computer program instructions 708 implementing an authorization server or administration server as described above. In operation, the processor loads the program instructions into the main memory and executes the program instructions to implement the features of an authorization server or administration server.

The storage device further includes storage areas 710 for previously described authorization and administration databases. In operation, the authorization and administration servers access the databases to add, modify, and delete affiliations of principals and to provide authorizations for the principals.

The main memory further includes a cache 711 for storage of dynamic access control entries 112 for caching of access rule evaluations as previously described.

The data processing system further includes a network device 712 coupled to the processor via the system bus. An administration or authorization server, hosted by the data processing system, uses the network device to communicate with clients and other servers over a communications network as previously described.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by claims supported by this application and the claims' equivalents rather than the foregoing description.

What is claimed is:

1. A method of providing access to a service for a principal, the method comprising:
receiving a request for authorization, the request for authorization including contextual data;
selecting an access rule using the contextual data; and
determining an action using the access rule and the contextual data, the action indicating the principal's access to the service.

2. The method of claim 1, wherein the access rule is associated with the service in a database.

3. The method of claim 1, wherein the contextual data is received from a client via a communications network, the authorization client coupled to the service.

4. The method of claim 3, further comprising:
transmitting the action to the client via the communications network; and
providing access for the principal to the service when the client determines the action indicates the principal is authorized to access the service.

5. The method of claim 1, wherein:
the access rule includes a database query template for generation of a database query; and
determining an action further includes evaluating the access rule by:
generating a database query using the contextual data and the query template;
querying a database using the generated query; and
determining an access rule evaluation using a response to querying of the database; and
determining the action using the access rule evaluation.

6. The method of claim 5, further comprising caching the access rule evaluation.

7. The method of claim 6, further comprising:
receiving a subsequent authorization request; and
determining an action in response to the subsequent authorization request using the cached access rule evaluation.

8. The method of claim 1, wherein:
the access rule includes a proposition; and
determining an action further includes:
generating an access rule evaluation by evaluating the proposition; and
determining the action using the access rule evaluation.

9. The method of claim 8, wherein the proposition includes a reference to a system variable.

10. The method of claim 8, wherein the proposition includes a reference to a principal attribute.

11. The method of claim 8, wherein the proposition includes a reference to a client contextual datum.

12. The method of claim 8, further comprising caching the access rule evaluation.

13. The method of claim 12, further comprising:
receiving a subsequent authorization request; and
determining an action in response to the subsequent authorization request using the cached access rule evaluation.

14. A method of providing access to a service for a principal by a server via a communications network, the method comprising:
receiving a request for authorization by the server via the communications network from a client coupled to the service, the request for authorization including contextual data;
selecting an access rule, using the contextual data, from a database by the server;
determining an action by the server using the access rule and the contextual data, the action indicating the principal's access to the service; and
transmitting the action by the server via the communications network to the client.

15. The method of claim 14, further comprising:
providing access for the principal to the service when the client determines the action indicates the principal is authorized to access the service.

16. The method of claim 14, wherein:
the access rule includes a database query template for generation of a database query; and
determining an action by the server further includes evaluating the access rule by:
generating a database query using the contextual data and the query template;
querying a database using the generated query; and
determining an access rule evaluation using a response to querying of the database; and
determining the action using the access rule evaluation.

17. The method of claim 16, further comprising caching the access rule evaluation in a dynamic access control entry by the server.

18. The method of claim 17, further comprising:
receiving a subsequent authorization request by the server via the communications network from the client; and
using the cached access rule evaluation by the server to determine an action for the subsequent authorization request.

19. The method of claim 14, wherein:
the access rule includes a proposition; and
determining an action by the server further includes:
generating an access rule evaluation by evaluating the proposition; and
determining the action using the access rule evaluation.

20. The method of claim 19, wherein the proposition includes a reference to a system variable.

21. The method of claim 19, wherein the proposition includes a reference to a principal attribute.

22. The method of claim 19, wherein the proposition includes a reference to a client contextual datum.

23. A data processing apparatus for providing access to a service for a principal, comprising:
a processor; and
a memory coupled to the processor, the memory having program instructions executable by the processor stored therein, the program instructions including:
receiving a request for authorization, the request for authorization including contextual data;
selecting an access rule using the contextual data; and
determining an action using the access rule and the contextual data, the action indicating the principal's access to the service.

24. The data processing apparatus of claim 23, further comprising a database coupled to the processor, the access rule associated with the service in the database.

25. The data processing apparatus of claim 23, the program instructions for receiving a request for authorization further including receiving the request for authorization from a client via a communications network, the authorization client coupled to the service.

26. The data processing apparatus of claim 25, the program instructions further including:
transmitting the action to the client via the communications network whereby access to the service for a principal is provided when the client determines the action indicates the principal is authorized to access the service.

27. The data processing apparatus of claim 23, wherein:
the access rule includes a database query template for generation of a database query; and
the program instructions for determining an action further include evaluating the access rule by:
generating a database query using the contextual data and the query template;
querying a database using the generated query; and
determining an access rule evaluation using a response to querying of the database; and
determining the action using the access rule evaluation.

28. The data processing apparatus of claim 27, further comprising a memory cache coupled to the processor; and the program instructions further including caching the access rule evaluation in the memory cache.

29. The data processing apparatus of claim 28, the program instructions further including:
receiving a subsequent authorization request; and
determining an action in response to the subsequent authorization request using the cached access rule evaluation.

30. The data processing apparatus of claim 23, wherein:
the access rule includes a proposition; and
the program instructions for determining an action further include:
generating an access rule evaluation by evaluating the proposition; and
determining the action using the access rule evaluation.

31. The data processing apparatus of claim 30, wherein the proposition includes a reference to a system variable.

32. The data processing apparatus of claim 30, wherein the proposition includes a reference to a principal attribute.

33. The data processing apparatus of claim 30, wherein the proposition includes a reference to a client contextual,datum.

34. The data processing apparatus of claim 30, further comprising a memory cache coupled to the processor; and the program instructions further including caching the access rule evaluation in the memory cache.

35. The data processing apparatus of claim 34, further comprising a memory cache coupled to the processor; and the program instructions further including caching the access rule evaluation in the memory cache.
